(19) United States
(12) Patent Application Publication
(10) Pub. No.: US 2012/0019442 A1
(43) Pub. Date: Jan. 26, 2012

(54) POINTING DEVICE FOR USE WITH A COMPUTER AND METHODS OF OPERATION AND CALIBRATION THEREOF

(76) Inventor: Andrew Christopher Warne, London (GB)

(21) Appl. No.: 12/842,483

(22) Filed: Jul. 23, 2010

(51) Int. Cl. G06F 3/033

(52) U.S. Cl. 345/157

(57) ABSTRACT

A pointing device is provided for use with a computer and display screen. The line of sight of the pointing device is determined with reference to one or more electromagnetic radiation sources located adjacent to the screen. The pointing device includes a processor for receiving signals from a sensor within the device, processing the signals with respect to calibration data to generate co-ordinate data which identifies a location on the screen at which the pointing device is directed, and outputting the co-ordinate data for transmission to the computer. Thus, dedicated software does not need to be installed on the computer to enable it to interact with the pointing device. Methods of operating the pointing device are also described, together with methods of calibration. According to a further aspect, the device sensor is mounted in the pointing device with the centre line of its field of view at an acute angle with respect to the reference axis of the device. The sensor is orientated towards a radiation source located adjacent the periphery of the display screen, thereby increasing the range of movement of the pointing device in practice over which the emitter remains within the field of the sensor.

### FIELD OF INVENTION

The present invention relates to a pointing device for use with a computer having an associated display screen. It particularly suitable for use as a controlling apparatus for interaction with computer-implemented applications such as games and simulations.

### BACKGROUND OF THE INVENTION

Many computer applications employ a peripheral controller which enables the user to interact with and control the operation of the application. In many cases, a controller is used which is hand-held in “free air”, rather than being moved across a fixed surface such as a desk (as in the case of a computer mouse) or having a moveable portion at a fixed location such as a tracker ball.

Existing hand-held controllers may take the form of a gaming light gun, or a pointer for use during presentations which allows a user to move a computer generated icon over a screen by directing the device at the screen.

A common type of gaming light gun consists of a device comprising a lens and an optical sensor which detects the scanned light beam on a CRT screen and uses a timing method to calculate its aimed position. In this type of device, the gun may send timing information to a host computer via a universal serial bus (USB) input.

More recently, pointing devices for use in gaming applications have been developed which operate together with two infrared emitters placed in a fixed location on the periphery of the screen, with the pointing device having an image sensor which recognises these emitters. The image sensor may comprise a camera integrated circuit such as a CMOS sensor. The pointing device includes a processor which outputs data comprising the X and Y locations of the infrared emitters within the image of the camera. This type of system does not rely on detection of any part of the computer screen and can therefore be used with non-CRT devices such as LCD screens. Furthermore, it does not require any knowledge of the timing of the actual video signal, and these systems do not require access to the video signal via the sensor or by a direct connection to the video signal.

The pointing device employed in the infrared tracking system described above is a “relative location” device. The user moves a pointer around the computer screen, or causes some other effect such as scrolling of the screen in the direction of the movement of the pointing device. The actual amount of movement of the pointer on the screen will depend on the location of the user in relation to the screen with its attached infrared emitters. If the user moves closer to the screen, the amount of movement of the pointing device for a given movement of the screen cursor will decrease. Furthermore, the physical layout of the apparatus such as the size of the screen and the location of the infrared emitters will change the relationship between the aim of the pointing device and the indicator on the screen.

These limitations render this type of system only suitable for applications where the user has visual feedback of the position of the cursor on the screen, in the same manner as a computer mouse which operates by visually indicating its position. In terms of a light gun employed in gaming, this limits its use to a game which has an on-screen cross-hair or other pointer indicating aim position.

In applications which do not have any visible on-screen cursor, it is necessary to enhance the system by providing a method of calibrating the device, so that following successful calibration, the “invisible cursor” or area of action on the screen, closely follows the aim of the physical body of the pointing device, which, in the case of a gun, would be the gun sights.

In order to achieve this calibration, the host software application (for example a computer game) will, during initial setup of the system, prompt the user to perform certain actions such as pointing the gun at a certain known location, taking a reading, then repeating this for a number of other locations. The computer software application performs the following actions:

1. Receive a user instruction to initiate the calibration process;

2. Instruct the user to aim at a particular screen location;

3. Store the X and Y co-ordinates of the infrared emitter as detected by the pointing device sensor;

4. Repeat steps 2 and 3 for other locations (usually at the corners of the screen);

5. Calculate calibration values, such as an offset value for each X or Y co-ordinate and a scaling value for each X or Y co-ordinate;

6. Store these values in memory.

During operation of the system, the pointing device sends X and Y co-ordinates of each infrared emitter to the host system. The host system software continually performs the necessary compensation calculations based on its stored calibration values, held in memory.

### SUMMARY OF THE INVENTION

The present invention provides a pointing device for use with a computer having a display screen and a localised electromagnetic radiation source provided to one side of the screen, the device comprising:

a sensor for detecting radiation from the radiation source and operable to output a sensor signal representing position data indicative of the position of the radiation source in its field of view;

a processor having an input and an output; and

a memory for storing calibration data,

wherein the processor is arranged to receive the sensor signal at its input, process the position data with respect to the calibration data to generate coordinate data which identifies a location on the screen at which the pointing device is directed, and output the coordinate data at its output for transmission to the computer.

Thus, in a pointing device embodying the present invention, processing of signals received from the sensor of the device is carried out within the pointing device itself. This enables the pointing device to send compensated X and Y co-ordinate data to the associated computer. This enables the computer to directly follow the “line of sight” aim of the pointing device body without having to carry out further processing itself. In other words, the device sends “absolute” aim position data to the computer, rather than “relative” position information.

Thus, the pointing device is not dependent on any special characteristics of the host computer system or its software and is therefore compatible with software not originally intended to be used with this type of pointing device.

The device can interface with the computer by means of a standard interface such as a USB, and the data may be sent in a format which the computer system's operating system can readily interpret. Fully calibrated data is passed to the computer application without the need for any custom driver or other dedicated software on the computer. This may remove the need for the user to install and run additional software on the computer to enable it to inter-operate with the pointing device. The pointing device can interface with the PC in the same way as an existing standard position controller such as a mouse configured as an X, Y absolute mouse device.

Thus, developers of computer software for use with the pointing device do not need to concern themselves with the handling of the pointing device and its output data, in contrast with existing pointing devices.

Preferably, the sensor is able to detect infrared radiation. The processor may be arranged to compensate for tilt of the pointing device away from an upright orientation with reference to the position data associated with each radiation source. Alternatively, or in addition, the processor may be arranged to compensate for changes in the distance between the pointing device on the screen with reference to the position data associated with each radiation source.

It will be appreciated that reference herein to “one side” or “a side” of a display screen refers to any side, including any one of the top, bottom, left and right sides of a rectangular screen.

The pointing device may be may be provided in combination with two localised electromagnetic radiation sources for location in use adjacent respective opposite sides of the associated screen.

In a further embodiment, the pointing device may be provided in combination with three localised electromagnetic radiation sources, wherein in use, two of the radiation sources are located adjacent to one of the sides of the screen (preferably the top or the bottom side), and the other radiation source is located adjacent to an opposite side (preferably the bottom or the top, respectively) at the periphery of the screen.

The radiation sources are preferably in the form of infrared radiation sources although it will be appreciated that other sources of electromagnetic radiation may be employed.

The processor may be implemented in the form of a single microprocessor, or comprise a number of signal and/or data processing modules in combination.

The present invention further provides a method of operating a method of operating a pointing device for a computer having a display screen and a localised electromagnetic radiation source provided to one side of the screen, wherein the pointing device comprises a sensor, a processor and a memory, the method comprising the steps of:

detecting radiation from the radiation source with the sensor;
outputting a sensor signal from the sensor representing position data indicative of the position of
the radiation source in its field of view;
receiving the sensor signal in the processor;
processing the position data with the processor with respect to calibration data stored in the memory to generate coordinate data which identifies a location on the screen at which the pointing device is directed; and
transmitting the coordinate data to the computer.

Furthermore, the invention provides a method of calibrating a method of calibrating a pointing device for use with a computer having a display screen and a localised electromagnetic radiation source provided to one side of the screen, wherein the pointing device comprises a sensor, a processor and a memory, the method comprising the steps of:

(a) transmitting a first signal from the pointing device to the computer which identifies a first location on the screen and instructs the computer to indicate this location on the screen;
(b) receiving in the processor a first sensor signal from the sensor, the first sensor signal representing first position data indicative of the position of the radiation source in its field of view when the device is pointed at the first location;
(c) repeating steps (a) and (b) in relation to second and third different screen locations to generate second and third respective sensor signals representing second and third position data, respectively;
(d) processing the first, second and third position data in the processor to generate calibration data; and
(e) storing the calibration data in the memory, such that the processor is able to adjust position data subsequently received from the sensor with respect to the calibration data to generate coordinate data which identifies a location on the screen at which the pointing device is directed.

Thus, calibration of the pointing device may be performed without requiring installation of any dedicated calibration software on the host computer.

According to a further aspect, the present invention provides a pointing device for use with a computer having a display screen and a localised electromagnetic radiation source to the side of the screen, the device comprising:

a processor;

a sensor for detecting radiation from the radiation source and operable to output a sensor signal representing position data indicative of the position of the radiation source in its field of view; and

a reference axis which represents the line along which the device is pointed by a user, wherein the sensor is mounted in the pointing device with the centre line of its field of view at an acute angle with respect to the reference axis.

This allows use of a “line of sight” device closer to the associated screen than would otherwise be the case. This serves to increase the effective, practical field of view relative to a pointing device in which the sensor centre line is parallel to the reference line of sight of the device body.

Preferably, the sensor is mounted in the pointing device with the centre line of its field of view at an angle in the range 8-34° with respect to the reference axis of the pointing device. More particularly, the centre line of the sensor may form an angle of about 16° with the reference axis.

### BRIEF DESCRIPTION OF THE DRAWINGS

Embodiments of the invention will now be described by way of example and with reference to the accompanying schematic drawings and flow diagrams, wherein:

FIG. 1 is a perspective view of a pointing device embodying the invention in combination with a host computer, a display screen and infrared emitters;

FIG. 2 is a flow diagram relating to a method of use of a pointing device embodying the present invention;

FIG. 3 is a flow diagram representing a method of calibration of a pointing device embodying the present invention;

FIG. 4 is a perspective side view of a circuit board of a pointing device embodying the present invention; and

FIG. 5 is a side view of a pointing device embodying a further aspect of the present invention in combination with a display screen.

### DETAILED DESCRIPTION OF THE DRAWINGS

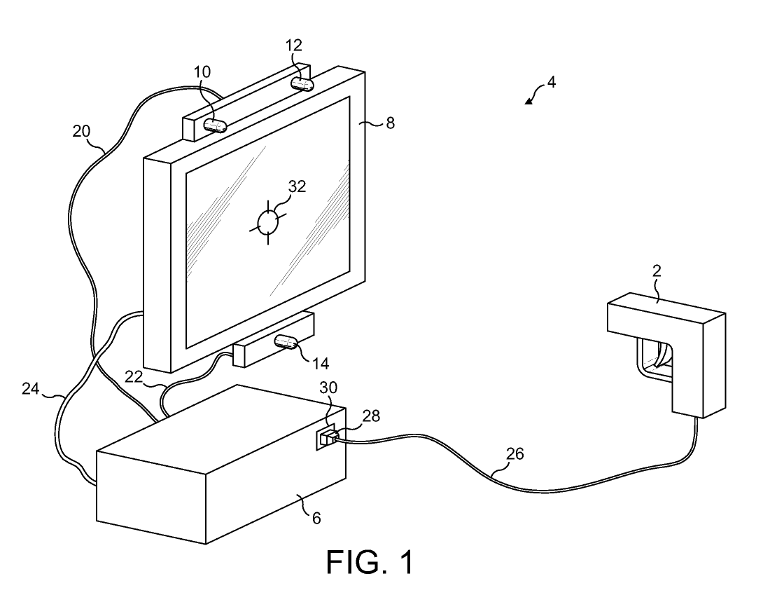

A pointing device 2 embodying the present invention is depicted in FIG. 1 as part of a gaming system 4. The system also includes a host computer 6 and a display screen 8. Electromagnetic radiation sources in the form of infrared emitters (10, 12 and 14) are disposed adjacent to the periphery of the display screen. Emitters 10 and 12 are both next to the upper edge of the screen, whilst emitter 14 is next to the opposite, lower edge of the screen.

The components shown in FIG. 1 are connected together by wires (20, 22, 24 and 26), but it will be appreciated that one or more of these wired connections may be replaced by a wireless link.

The pointing device 2 is connected via wire 26 and a plug 28 to a USB port 30 of the host computer 6.

During operation, the pointing device 2 uses internally stored calibration factors to continually calculate the absolute X and Y aim of the pointing device body. It sends these X and Y co-ordinates to the host computer 6. These co-ordinates are readily interpreted by the host computer to identify a location on the display screen 8. In the embodiment illustrated, the host computer sends signals to the display screen which cause a crosshairs 32 to be displayed on the screen at the point at which the pointing device body is directed.

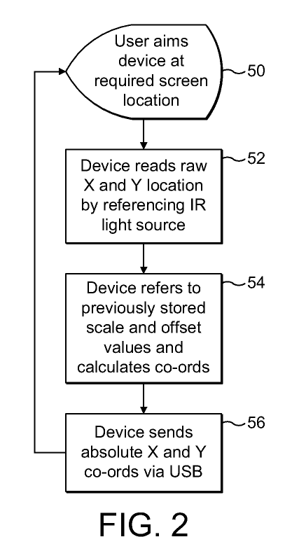

FIG. 2 shows a flow diagram representing a method of operating a pointing device in accordance with the present invention. In step 50, the user aims the pointing device at a required screen location. The sensor of the device detects radiation emitted by one or more radiation sources adjacent to the display screen and outputs corresponding signals to the device processor. The signals identify the locations of the emitters in the field of view on the sensor. These signals are converted into position data by the processor in step 52.

In step 54, this position data is processed by the processor with respect to previously stored calibration data held in memory within the pointing device. These calculations generate co-ordinate data identifying a specific location on the screen at which the pointing device is directed. In step (56), the pointing device transmits this absolute X and Y co-ordinate data to the host computer, for example via a USB input. The method then returns to step (50) to capture a further set of position data via the pointing device sensor.

Where the pointing device is used in combination with two or more radiation sources, the sensor provides information relating to each of the sources within its field of view. The corresponding position data sets may then be employed in the process of calculating the co-ordinate data.

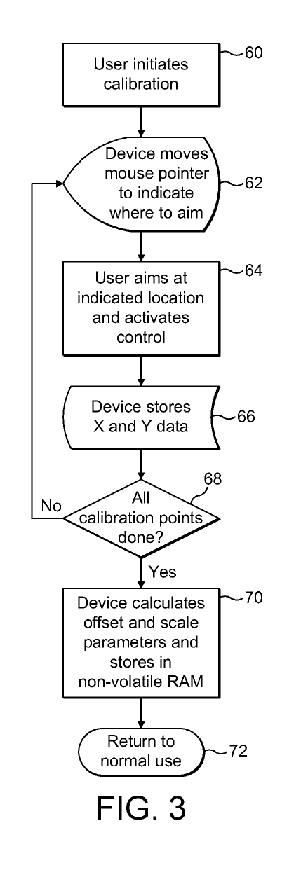

A flow diagram representing a method of calibrating a pointing device embodying the present invention is shown in FIG. 3.

In step 60, the user initiates the calibration procedure. This may be achieved by activating a push button on the device, or holding down a push button or trigger on the device for a pre-determined period of time. The processor is configured to detect when the user has initiated calibration in a pre-defined manner.

In step 62, the processor transmits a signal to the host computer which causes the computer to indicate a particular location on the display screen. For example, a mouse cursor shown on the screen may move to a pre-defined screen location or flash at the location to indicate that a calibration step needs to be performed. The user then aims the pointing device at the indicated location and activates a control such as a push button on the pointing device (step 64). At this point, the position data derived via the device sensor is stored by the processor in memory (step 66). Steps 62-66 are then repeated for two or more further screen locations. Preferably, the locations are widely spaced apart on the screen, for example at respective corners or one of the more central points along edges of the screen. For example, the locations are the top left and right corners and the middle of the bottom edge of the screen.

When it is determined in step 68 that the required number of calibration points have been captured, the method moves to step 70. The processor of the pointing device carries out calculations using the stored position data to generate calibration data which is stored in the memory. This data is then available to adjust position data captured subsequently to generate co-ordinate data identifying where the pointing device is directed at on the screen in use of the pointing device (step 72).

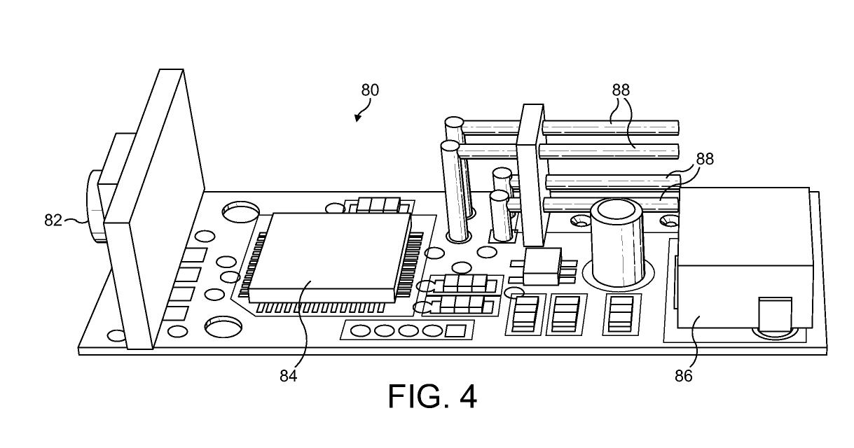

A circuit board 80 for mounting inside a pointing device embodying the present invention is shown in FIG. 4. An infrared sensor module 82 is mounted at one end of the board. It is coupled to a microcontroller 84. The microcontroller includes a processor and memory. The memory includes non-volatile memory for calibration data storage. Output signals from the microcontroller are sent to the host system via a USB connector 86. Pins 88 are for connection to actuators on the device such as a trigger and/or other push buttons.

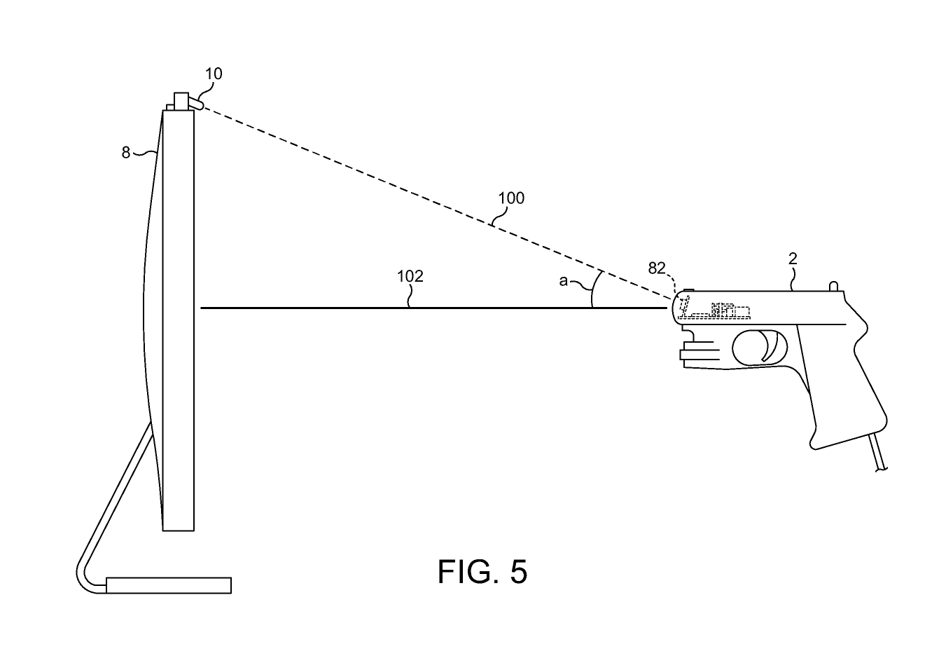

A pointing device 2 is depicted in FIG. 5 according to a further aspect of the present invention. The radiation sensor module 82 is mounted within the pointing device with the centre line of its field of view at an acute angle with respect to the axis along which the pointing device is aimed by a user. As indicated in the figure, an angle “a” is formed between the centre line 100 of the field of view of the sensor and reference axis 102 which corresponds to the pointing direction of the device body. Thus, it can be seen in the typical configuration shown in FIG. 5, whilst the pointing device is aimed centrally at the screen, the sensor axis intersects with the radiation source 10 mounted on the upper front edge of the display screen.

This overcomes a limitation associated with known infrared object tracking position systems, which is particularly encountered when using a pointing device in close proximity to a screen. In known “relative” location devices, there is feedback to the user from the screen by means of an indicator on the screen which moves as the pointing device is moved. However, in a calibrated device as described herein, this feedback may be omitted, making it more important that the calculated co-ordinate data accurately follows the aim of the physical body of the device. Accordingly, it is particularly desirable for the infrared emitters to be within the field of view of the pointing device sensor at all times whilst the device is pointed at any position on the display screen. This may not be the case with known pointing devices when used close to the screen. With the sensor aligned with the pointing direction of the device, the limited field of view of the sensor can mean that the infrared emitters mounted adjacent to the periphery of the screen are no longer visible by the sensor.

According to the present aspect of the invention, the sensor is mounted at an angle relative to the centre line of the pointing device, so that the line of visual aim of the device no longer matches the actual aim of the camera sensor. Instead the sensor is angled upwardly towards the emitters adjacent to the screen.

It will be appreciated that where the emitters are located in use adjacent to another side of the screen, then the sensor angle can be similarly adjusted for closer alignment of its centre line with the emitters, when the pointing device is aimed at the centre of the screen.

For example, the sensor axis 100 may form an angle “a” of around 16° with respect to the pointing direction 102 of the pointing device. This is based on an average monitor size with a 19″ diagonal and an average distance of the pointing device from the screen of 600 mm.

An example of a calculation suitable for deriving co-ordinate data for transmission to a host computer from the pointing device is given below. These calculations are with regard to the X co-ordinate and corresponding calculations are carried out in relation to the Y co-ordinate.

The X co-ordinate transmitted to the host computer Vx is calculated as follows:

Vx=(Rx−Ox)/Sx

where Rx is a raw value corresponding to the X location of an infrared emitter as measured by the pointing device sensor, and Ox is a position offset which is determined during calibration of the device.

Ox=LCALx

LCALx is a raw value corresponding to the X location of the infrared emitter as measured by the pointing device sensor and stored when the pointing device is aimed at the left-hand side of the screen during calibration.

Sx is a scale factor which is calculated during the calibration process, where

Sx=(RCALx−Ox)/RMAXx

RCALx is a raw value corresponding to the X location of the infrared emitter as measured by the device sensor when the device is aimed at the right-hand side of the screen during calibration, and RMAXx is the absolute value of the X co-ordinate corresponding to the right-hand side of the display screen.

Compensation for tilt of the pointing device away from its upright position may be determined by measuring the difference in the Y positions of left and right emitters located adjacent upper edge of the display screen. It will be appreciated that tilt may also be detected from any other spaced arrangements of two emitters with reference to position data captured whilst the pointing device is in an upright position.

The effect of tilt increases as the pointing device is aimed lower down a screen. Tilting causes an increasing inaccuracy in the X value of the device aim is moved downwards. This may be addressed for example by applying a linear correction factor which increases as the aim moves down, or the tilt increases.

Where two or more emitters are employed, the device is preferably able to determine whether a user has moved towards or away from the screen, relative to the user's position during the calibration procedure. If the user moves backwards, two emitters will appear closer, whilst if the user moves forward, two emitters will appear further apart. If such changes are detected with reference to position data received from the device sensor, a correction factor can be applied by the processor of the pointing device. For example, this factor may be determined from a look-up table stored in the device memory. The effect of this is to adjust the Y co-ordinates calculated by the processor to a position lower down the screen if the user moves back, and further up the screen if the user moves forward, with the amount of adjustment increasing with increasing distance between the location at which the pointing device is located and the centre of the screen.

Provision of three or more emitters enables the pointing device to differentiate between the user moving to one side of the display and the user moving further away from the display. For example, two emitters may be located adjacent to the top of the screen with a further emitter adjacent to the bottom (or vice versa). If the user moves to one side, a pair of emitters located at the top of the screen will appear closer, but the spacing between the emitters at the top and bottom will remain substantially the same. If the user moves backwards, a pair of emitters at the top will appear closer, and also the spacing between the top emitters and the bottom emitter will reduce.

1. A pointing device for use with a computer having a display screen and a localised electromagnetic radiation source provided to one side of the screen, the device comprising:
a sensor for detecting radiation from the radiation source and operable to output a sensor signal representing position data indicative of the position of the radiation source in its field of view;
a processor having an input and an output; and
a memory for storing calibration data,
wherein the processor is arranged to receive the sensor signal at its input, process the position data with respect to the calibration data to generate coordinate data which identifies a location on the screen at which the pointing device is directed, and output the coordinate data at its output for transmission to the computer.

2. A device of claim 1, wherein the sensor is able to detect infrared radiation.

3. A device of claim 1, wherein the sensor is operable to output a sensor signal representing position data indicative of the respective positions of at least two radiation sources in its field of view, and the processor is arranged to generate the coordinate data with reference to the position data associated with the at least two radiation sources.

4. A device of claim 1 in combination with at least two localised electromagnetic radiation sources, wherein the sensors are locatable adjacent opposite sides of the screen.

5. A device of claim 1 in combination with three localised electromagnetic radiation sources, wherein two of the sensors are locatable adjacent one side of the screen and the third sensor is locatable adjacent an opposite side of the screen.

6. A method of operating a pointing device for a computer having a display screen and a localised electromagnetic radiation source provided to one side of the screen, wherein the pointing device comprises a sensor, a processor and a memory, the method comprising the steps of:
detecting radiation from the radiation source with the sensor;
outputting a sensor signal from the sensor representing position data indicative of the position of the radiation source in its field of view;
receiving the sensor signal in the processor;
processing the position data with the processor with respect to calibration data stored in the memory to generate coordinate data which identifies a location on the screen at which the pointing device is directed; and
transmitting the coordinate data to the computer.

7. A method of claim 6, wherein at least two localised electromagnetic radiation sources are provided adjacent to the screen, and the processing step includes compensating for tilt of the pointing device away from its upright orientation by reference to the position data indicative of the detected locations of the sources.

8. A method of claim 6, wherein at least two localised electromagnetic radiation sources provided adjacent to the screen, and the processing step includes compensating for changes in the distance between the pointing device and the screen by reference to the position data indicative of the detected locations of the sources.

9. A method of calibrating a pointing device for use with a computer having a display screen and a localised electromagnetic radiation source provided to one side of the screen, wherein the pointing device comprises a sensor, a processor and a memory, the method comprising the steps of:
(a) transmitting a first signal from the pointing device to the computer which identifies a first location on the screen and instructs the computer to indicate this location on the screen;
(b) receiving in the processor a first sensor signal from the sensor, the first sensor signal representing first position data indicative of the position of the radiation source in its field of view when the device is pointed at the first location;
(c) repeating steps (a) and (b) in relation to second and third different screen locations to generate second and third respective sensor signals representing second and third position data, respectively;
(d) processing the first, second and third position data in the processor to generate calibration data; and
(e) storing the calibration data in the memory, such that the processor is able to adjust position data subsequently received from the sensor with respect to the calibration data to generate coordinate data which identifies a location on the screen at which the pointing device is directed.

10. A pointing device for use with a computer having a display screen and a localised electromagnetic radiation source to the side of the screen, the device comprising:
a processor;
a sensor for detecting radiation from the radiation source and operable to output a sensor signal representing position data indicative of the position of the radiation source in its field of view; and
a reference axis which represents the line along which the device is pointed by a user,
wherein the sensor is mounted in the pointing device with the centre line of its field of view at an acute angle with respect to the reference axis.

11. A pointing device of claim 10, wherein the sensor is mounted in the pointing device with the centre line of its field of view at an angle in the range 8 to 34 degrees with respect to the reference axis.

12. A pointing device of claim 11, wherein the sensor is mounted in the pointing device with the centre line of its field of view at an angle of about 16 degrees with respect to the reference axis.

13. A system including a host computer, a display screen, and a pointing device of claim 1.

14. A system including a host computer, a display screen, and a pointing device of claim 10.
